(19) United States
(12) Patent Application Publication
(10) Pub. No.: US 2010/0033465 A1
(43) Pub. Date: Feb. 11, 2010

(54) Display Device with Secure Matrix Screen

(75) Inventors: Laurent Canal, Merignac (FR); Patrice Eudeline, Bordeaux (FR); Jean-Marie Multon, Pessac (FR); Vincent Vieira, Eysines (FR); Gerard Voisin, St Medard en Jalles (FR)

Correspondence Address: LARIVIERE, GRUBMAN & PAYNE, LLP, 19 UPPER RAGSDALE DRIVE, SUITE 200, MONTEREY, CA, 93940, US

(73) Assignee: Thales, Neuilly Sur Seine (FR)

(21) Appl. No.: 12/510,407

(22) Filed: Jul. 28, 2009

(30) Foreign Application Priority Data
Aug. 8, 2008 (FR) 08 04538

(51) Int. Cl. G06F 3/038

(52) U.S. Cl. 345/211; 345/92

(57) ABSTRACT

The technical field of the invention is that of secure display devices. The latter comprise at least one matrix screen, electronics for controlling the screen, a fault-detection circuit and electronic means for managing the display device, the screen consisting of pixels placed in lines and in columns, the lines of pixels being controlled by an electronic “drivers” card comprising electronic means arranged so as to generate a first electronic signal representative of the correct or incorrect operation of the said electronic “drivers” card, the fault-detection circuit arranged so as to generate, from the first signal, a second signal processed by the electronic means for managing the display device. The display device according to the invention comprises an analogue circuit for electronic quenching of the image controlled by the fault-detection circuit so that, when the first electronic signal is representative of the incorrect operation of the card, the analogue quenching circuit causes the erasure of the image on the screen, the screen then being uniformly monochrome. It is possible, for this purpose, to act on the control voltage of the counter-electrode.

### PRIORITY CLAIM

This application claims priority to French Patent Application Number 08 04538, entitled Display Device with Secure Matrix Screen, filed on Aug. 8, 2008.

### BACKGROUND OF THE INVENTION

1. Field of the Invention

The field of the invention is that of display devices used in a critical environment. For a certain number of applications and notably in the field of aircraft instrument panels, it is imperative that the display devices constantly show reliable information. Therefore, in cockpit displays, any incorrect image display that cannot be detected is not acceptable.

2. Description of the Prior Art

Cockpit displays are most frequently flat matrix screens. The most widely-used technologies use liquid crystals or organic light-emitting diodes. Screens using these technologies are called LCD, the acronym for “Liquid Crystal Display” or OLED, the acronym for “Organic Light-Emitting Diode”. An LCD or OLED screen may be considered to be an image memory that is refreshed periodically by electronic circuits and read by photons. More precisely, the video image is controlled by two series of circuits called “drivers” controlling the lines and the columns of the display matrix. The image is shown on the display screen by the “drivers” of the columns and written by the “drivers” of the lines.

A failure of the column “drivers” causes the writing of the same content on all the lines. The image then consists of vertical strips. In this case, the failure of the display can be easily detected and there is no safety problem. Conversely, if the line “drivers” fail, the control electronics can no longer write images and the last image shown is retained until the pixels are discharged by leakage currents. Because of the quality of current electronics, this discharge may take more than a minute. During this time lapse, the pilot cannot know that the image shown is incorrect and likely to comprise false information. This type of failure is often classified as “catastrophic” by aircraft manufacturers. Its probability must be less than 10⁻⁹ and it is necessary to monitor its appearance and notify the pilots of the problem.

To solve this problem, use is made of an electronic system as shown in FIG. 1, and comprising a specific detection circuit C.D.S. placed between the electronic card C.D.L supporting the line drivers D.L. and the electronic card C.P. supporting the processor of the display device. It operates as follows. The “line drivers” card C.D.L. sends a signal S.E. to write lines to the detection circuit C.D.S. This signal S.E. can take many forms. Amongst other things, it may be a signal representative of the supply current or the state of the analogue outputs. The detection circuit processes this received signal and generates an output signal D.S. in the form of an electronic discrete of which the state is representative of the validity of the received signal and therefore of the operating state of the “line drivers” card. The output signal D.S. is sent to the processor of the equipment. The software of the processor processes this signal and takes the necessary measures when the signal indicates a failure of the “line drivers” card. It can therefore alert the pilot to come and switch off the display device, cause reconfigurations of the instrument panel, etc.

The main advantage of this method is that the equipment processor manages the failure and decides on the sanction. It can therefore be adapted according to the envisaged applications and the requirements of the customer for one and the same item of equipment. Its major disadvantage is its cost. Specifically, it is very clear that, for certain applications and notably in the aviation field, the software processing this type of failure must be highly secure. It is therefore very expensive to develop, to upgrade and to validate.

### SUMMARY OF THE INVENTION

The display device according to the invention comprises a detection circuit which acts directly on an analogue electric quenching circuit comprising very few electronic elements and, consequently, being extremely reliable. This is how the problems posed by software management are simply resolved.

More precisely, the subject of the invention is a display device comprising at least one matrix screen, electronics for controlling the screen, a fault-detection circuit and electronic means for managing the display device, the screen consisting of pixels placed in lines and in columns, the lines of pixels being controlled by an electronic “drivers” card comprising electronic means arranged so as to generate a first electronic signal representative of the correct or incorrect operation of the said electronic “drivers” card, the fault-detection circuit arranged so as to generate, from the first signal, a second signal processed by the electronic means for managing the display device, characterized in that the display device also comprises an analogue circuit for electronic quenching of the image controlled by the fault-detection circuit so that, when the first electronic signal is representative of the incorrect operation of the card, the analogue quenching circuit causes the erasure of the image on the screen, the screen then being uniformly monochrome.

Advantageously, the screen being a TFT liquid crystal matrix screen, the liquid crystal display faceplate comprising at least one first “backplane” electrode and a matrix of electrodes controlled by the electronic “drivers” card and comprising the control transistors, the voltage applied to the backplane in nominal operation being at a first value, the minimal voltage applied to the line drivers having a second value, the analogue quenching circuit comprises means making it possible, in the event of incorrect operation of the “drivers” card, to apply to the backplane a voltage having a third value equal to the second reduced value of a threshold voltage, the said threshold voltage being sufficient to uniformly turn all the transistors on.

### BRIEF DESCRIPTION OF THE DRAWINGS

The invention will be better understood and other advantages will appear on reading the following description given in a non-limiting manner and thanks to the appended figures amongst which:

FIG. 1, already described, represents a display device comprising a fault-detection circuit according to the prior art;

FIG. 2 represents a display device comprising a fault-detection circuit and an analogue quenching circuit according to the invention.

### MORE DETAILED DESCRIPTION

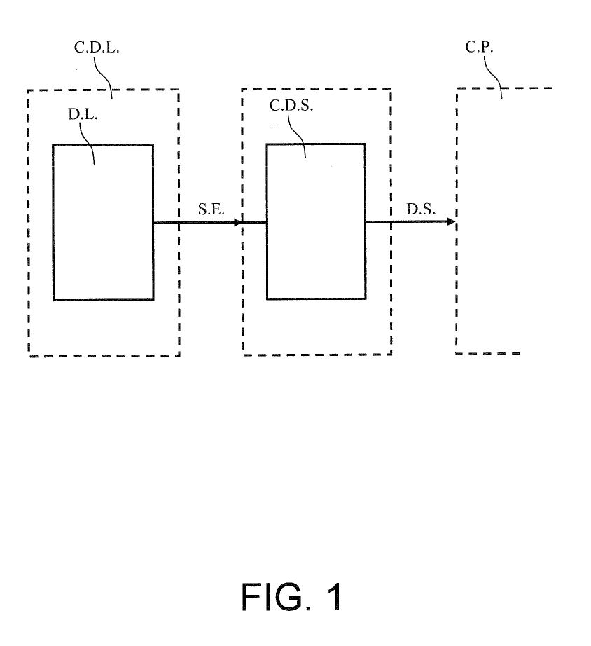

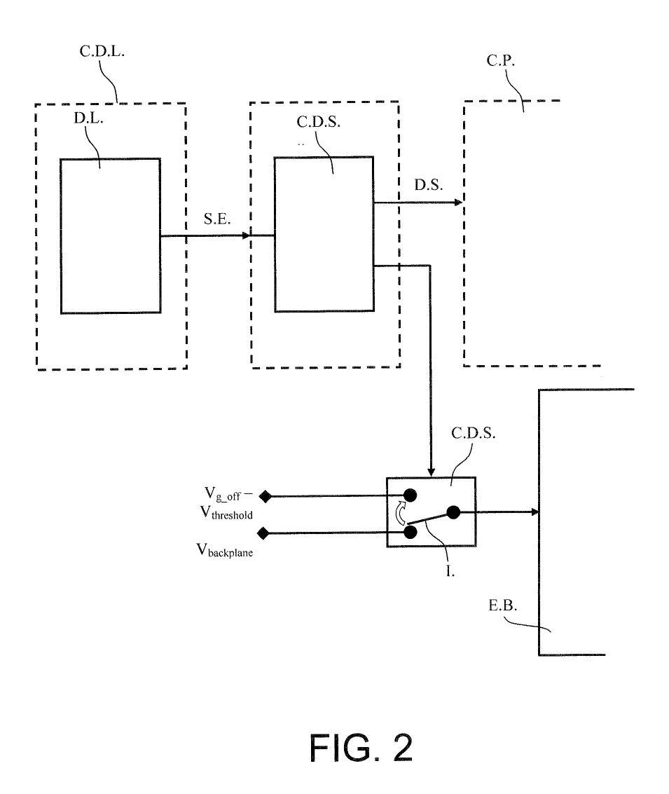

As an example, a display device according to the invention is shown in FIG. 2. In the case of FIG. 2, the display screen is a TFT, the acronym meaning “Thin Film Transistor”, liquid crystal matrix screen. This type of screen is currently the most common for aviation applications. The device comprises, like the device of FIG. 1, an electronic system comprising a specific detection circuit C.D.S. placed between the electronic card C.D.L. supporting the line drivers and the electronic card C.P. supporting the processor of the display device. In addition, the display device comprises an analogue electronic quenching circuit C.A.C. for electronic quenching of the image controlled by the fault-detection circuit C.D.S. so that, when the first electronic signal is representative of the incorrect operation of the card, the analogue quenching circuit causes the erasure of the image on the screen, the screen then being uniformly monochrome. The liquid crystal display faceplate comprises a first electrode E.B. called the “backplane” and a matrix of electrodes controlled by the electronic “drivers” card and comprising the control transistors. The voltage V_{backplane} applied to the backplane in nominal operation has a first value of the order of a few volts and the minimal voltage V_{g-off} applied to the line drivers has a second value also of a few volts.

The analogue quenching circuit C.A.C. comprises an analogue switch I making it possible, in the event of incorrect operation of the “drivers” card, to apply to the backplane a voltage having a third value equal to the second reduced value V_{g-off} of a threshold voltage V_{threshold}, the said threshold voltage being sufficient to uniformly turn all the transistors on. As an example, the voltage applied to the backplane may be approximately 7 volts below the low potential of the drivers. In this case, if the technology of the screen is, for example, of the TN (Twisted Nematic) type, it becomes uniformly black. If its technology is, for example, of the MVA (Multi domain Vertical Alignment), IPS (In Plane Switching) or AFFS (Advanced Fringe Field Switching) type, it will then become uniformly white. In both cases, the switching to the uniformly white or black screen is very rapid and the fault detection is immediate.

There are various variants of the device described in FIG. 2. Therefore, the analogue quenching circuit may quench the system for illuminating the display faceplate. This system usually consists either of cathode ray tubes or of light-emitting diodes. It is also possible, for example, to quench the system for modulating the illuminating sources making it possible to adjust the intensity of the sources, a system called “dimming”.

In all cases, the new means according to the invention are simple to apply, require only minor adaptations of existing electronic cards and are extremely robust and very reliable which is the intended aim.

What is claimed is:

1. Display device comprising at least one TFT liquid crystal matrix screen, electronics for controlling the screen, a fault-detection circuit and electronic means for managing the display device, the screen consisting of pixels placed in lines and in columns, the lines of pixels being controlled by an electronic “drivers” card comprising electronic means arranged so as to generate a first electronic signal representative of the correct or incorrect operation of the said electronic “drivers” card, the liquid crystal display face-plate comprising at least one first “backplane” electrode and a matrix of electrodes controlled by the electronic “drivers” card and comprising the control transistors, wherein the voltage applied to the backplane in nominal operation being at a first value, the minimal voltage applied to the line drivers having a second value, the display device also comprises an analogue circuit for electronic quenching of the image controlled by the fault-detection circuit so that, when the first electronic signal is representative of the incorrect operation of the card, the analogue quenching circuit comprises means making it possible to apply to the backplane a voltage having a third value equal to the second reduced value of a threshold voltage, the said threshold voltage being sufficient to uniformly turn all the transistors on, causing the erasure of the image on the screen, the screen then being uniformly monochrome.
